(19) United States
(12) Patent Application Publication
(10) Pub. No.: US 2025/0113031 A1
(43) Pub. Date: Apr. 3, 2025

(54) ADAPTIVE QUANTIZATION SHIFTING OFFSET FOR VIDEO AND IMAGE COMPRESSION

(71) Applicant: Tencent America LLC, Palo Alto, CA (US)

(72) Inventors: Motong XU, Palo Alto, CA (US); Roman CHERNYAK, Santa Clara, CA (US); Xin ZHAO, San Jose, CA (US); Madhu PERINGASSERY KRISHNAN, Mountain View, CA (US); Biao WANG, San Jose, CA (US); Lien-Fei CHEN, Hsinchu (TW); Yonguk YOON, Palo Alto, CA (US); Shan LIU, San Jose, CA (US)

(73) Assignee: Tencent America LLC, Palo Alto, CA (US)

(21) Appl. No.: 18/896,460

(22) Filed: Sep. 25, 2024

Related U.S. Application Data
(60) Provisional application No. 63/541,737, filed on Sep. 29, 2023.

(51) Int. Cl. H04N 19/124; H04N 19/176; H04N 19/18

(52) U.S. Cl. CPC H04N 19/124; H04N 19/176; H04N 19/18

(57) ABSTRACT

A method of video decoding includes receiving a bitstream that comprises coded information of a current block, the coded information of the current block includes coded bits of quantized transform coefficients in a transform domain of the current block, the coded information is also indicative of at least a scaling factor to be used during a dequantization of the quantized transform coefficients. The method also includes determining one or more quantization shifting offsets for a reconstruction of transform coefficients in the transform domain based on at least the scaling factor, reconstructing the transform coefficients from the quantized transform coefficients based on the one or more quantization shifting offsets, calculating residuals in a spatial domain of the current block based on the transform coefficients in the transform domain, and reconstructing the current block according to the residuals in the spatial domain.

### INCORPORATION BY REFERENCE

The present application claims the benefit of priority to U.S. Provisional Application No. 63/541,737, “Adaptive Quantization Shifting Offset for Video and Image Compression” filed on Sep. 29, 2023, which is incorporated by reference herein in its entirety.

### TECHNICAL FIELD

The present disclosure describes aspects generally related to video coding.

### BACKGROUND

The background description provided herein is for the purpose of generally presenting the context of the disclosure. Work of the presently named inventors, to the extent the work is described in this background section, as well as aspects of the description that may not otherwise qualify as prior art at the time of filing, are neither expressly nor impliedly admitted as prior art against the present disclosure.

Image/video compression can help transmit image/video data across different devices, storage and networks with minimal quality degradation. In some examples, video codec technology can compress video based on spatial and temporal redundancy. In an example, a video codec can use techniques referred to as intra prediction that can compress an image based on spatial redundancy. For example, the intra prediction can use reference data from the current picture under reconstruction for sample prediction. In another example, a video codec can use techniques referred to as inter prediction that can compress an image based on temporal redundancy. For example, the inter prediction can predict samples in a current picture from a previously reconstructed picture with motion compensation. The motion compensation can be indicated by a motion vector (MV).

### SUMMARY

Aspects of the disclosure include bitstreams, methods and apparatuses for video encoding/decoding. In some examples, an apparatus for video encoding/decoding includes processing circuitry.

Some aspects of the disclosure provide a method of video decoding. The method includes receiving a bitstream that comprises coded information of a current block, the coded information of the current block includes coded bits of quantized transform coefficients in a transform domain of the current block, the coded information is also indicative of at least a scaling factor to be used during a dequantization of the quantized transform coefficients. The method also includes determining one or more quantization shifting offsets for a reconstruction of transform coefficients in the transform domain based on at least the scaling factor, reconstructing the transform coefficients from the quantized transform coefficients based on the one or more quantization shifting offsets, calculating residuals in a spatial domain of the current block based on the transform coefficients in the transform domain, and reconstructing the current block according to the residuals in the spatial domain.

Some aspects of the disclosure provide a method of video decoding. The method includes receiving a bitstream that comprises coded information of a current block, the coded information of the current block includes coded bits of quantized transform coefficients in a transform domain of the current block, the coded information is indicative of a quantization shifting offset to be used for a reconstruction of at least a first transform coefficient in the transform domain. The method also includes reconstructing at least the first transform coefficient in the transform domain based on the quantization shifting offset, calculating residuals in a spatial domain of the current block based on at least the first transform coefficient in the transform domain and reconstructing the current block according to the residuals in the spatial domain.

Some aspects of the disclosure provide a method of video encoding. The method includes determining one or more quantization shifting offsets for a reconstruction of transform coefficients in a transform domain of a current block based on at least a scaling factor that is used during a dequantization of quantized transform coefficients. The method also includes reconstructing the transform coefficients from the quantized transform coefficients based on the one or more quantization shifting offsets, calculating residuals in a spatial domain of the current block based on the transform coefficients in the transform domain, reconstructing the current block according to the residuals in the spatial domain and encoding the current block as coded information in a bitstream. The coded information is indicative of at least the scaling factor.

Some aspects of the disclosure provide a method of video encoding. The method includes deriving a quantization shifting offset for a reconstruction of at least a first transform coefficient in a transform domain of a current block from quantized transform coefficients, and encoding the current block as coded information in a bitstream, the coded information is indicative of the quantization shifting offset.

Aspects of the disclosure also provide an apparatus for video encoding/decoding.

Aspects of the disclosure also provide a method for processing visual media data. In the method, a bitstream of visual media data is processed according to a format rule. For example, the bitstream may be a bitstream that is decoded/encoded in any of the decoding and/or encoding methods described herein. The format rule may specify one or more constraints of the bitstream and/or one or more processes to be performed by the decoder and/or encoder.

Aspects of the disclosure also provide a non-transitory computer-readable medium storing instructions which, when executed by a computer, cause the computer to perform any of the described methods for video decoding/encoding.

### BRIEF DESCRIPTION OF THE DRAWINGS

Further features, the nature, and various advantages of the disclosed subject matter will be more apparent from the following detailed description and the accompanying drawings in which:

FIG. 1 is a schematic illustration of an example of a block diagram of a communication system (100).

FIG. 2 is a schematic illustration of an example of a block diagram of a decoder.

FIG. 3 is a schematic illustration of an example of a block diagram of an encoder.

FIG. 4 shows a flow chart outlining a decoding process according to some aspects of the disclosure.

FIG. 5 shows a flow chart outlining a decoding process according to some aspects of the disclosure.

FIG. 6 shows a flow chart outlining an encoding process according to some aspects of the disclosure.

FIG. 7 shows a flow chart outlining an encoding process according to some aspects of the disclosure.

FIG. 8 is a schematic illustration of a computer system in accordance with an aspect.

### DETAILED DESCRIPTION

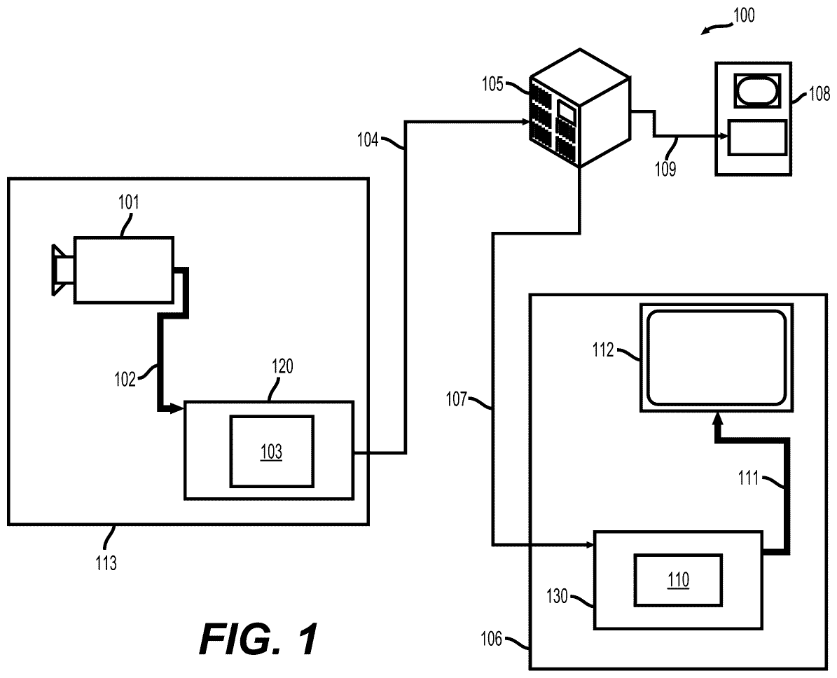

FIG. 1 shows a block diagram of a video processing system (100) in some examples. The video processing system (100) is an example of an application for the disclosed subject matter, a video encoder and a video decoder in a streaming environment. The disclosed subject matter can be equally applicable to other video enabled applications, including, for example, video conferencing, digital TV, streaming services, storing of compressed video on digital media including CD, DVD, memory stick and the like, and so on.

The video processing system (100) includes a capture subsystem (113), that can include a video source (101), for example a digital camera, creating for example a stream of video pictures (102) that are uncompressed. In an example, the stream of video pictures (102) includes samples that are taken by the digital camera. The stream of video pictures (102), depicted as a bold line to emphasize a high data volume when compared to encoded video data (104) (or coded video bitstreams), can be processed by an electronic device (120) that includes a video encoder (103) coupled to the video source (101). The video encoder (103) can include hardware, software, or a combination thereof to enable or implement aspects of the disclosed subject matter as described in more detail below. The encoded video data (104) (or encoded video bitstream), depicted as a thin line to emphasize the lower data volume when compared to the stream of video pictures (102), can be stored on a streaming server (105) for future use. One or more streaming client subsystems, such as client subsystems (106) and (108) in FIG. 1 can access the streaming server (105) to retrieve copies (107) and (109) of the encoded video data (104). A client subsystem (106) can include a video decoder (110), for example, in an electronic device (130). The video decoder (110) decodes the incoming copy (107) of the encoded video data and creates an outgoing stream of video pictures (111) that can be rendered on a display (112) (e.g., display screen) or other rendering device (not depicted). In some streaming systems, the encoded video data (104), (107), and (109) (e.g., video bitstreams) can be encoded according to certain video coding/compression standards. Examples of those standards include ITU-T Recommendation H.265. In an example, a video coding standard under development is informally known as Versatile Video Coding (VVC). The disclosed subject matter may be used in the context of VVC.

It is noted that the electronic devices (120) and (130) can include other components (not shown). For example, the electronic device (120) can include a video decoder (not shown) and the electronic device (130) can include a video encoder (not shown) as well.

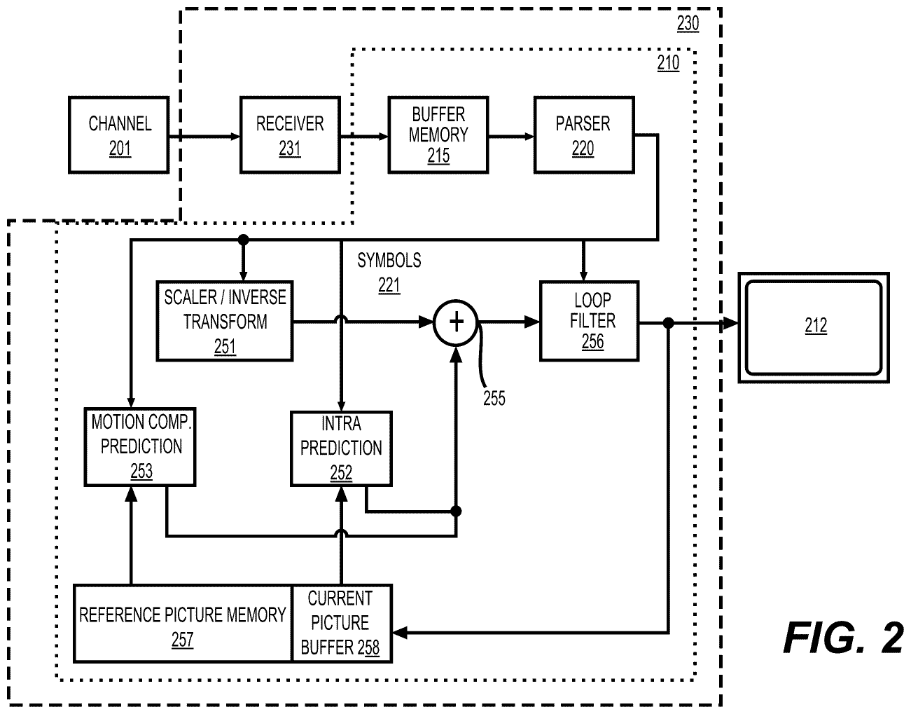

FIG. 2 shows an example of a block diagram of a video decoder (210). The video decoder (210) can be included in an electronic device (230). The electronic device (230) can include a receiver (231) (e.g., receiving circuitry). The video decoder (210) can be used in the place of the video decoder (110) in the FIG. 1 example.

The receiver (231) may receive one or more coded video sequences, included in a bitstream for example, to be decoded by the video decoder (210). In an aspect, one coded video sequence is received at a time, where the decoding of each coded video sequence is independent from the decoding of other coded video sequences. The coded video sequence may be received from a channel (201), which may be a hardware/software link to a storage device which stores the encoded video data. The receiver (231) may receive the encoded video data with other data, for example, coded audio data and/or ancillary data streams, that may be forwarded to their respective using entities (not depicted). The receiver (231) may separate the coded video sequence from the other data. To combat network jitter, a buffer memory (215) may be coupled in between the receiver (231) and an entropy decoder/parser (220) (“parser (220)” henceforth). In certain applications, the buffer memory (215) is part of the video decoder (210). In others, it can be outside of the video decoder (210) (not depicted). In still others, there can be a buffer memory (not depicted) outside of the video decoder (210), for example to combat network jitter, and in addition another buffer memory (215) inside the video decoder (210), for example to handle playout timing. When the receiver (231) is receiving data from a store/forward device of sufficient bandwidth and controllability, or from an isosynchronous network, the buffer memory (215) may not be needed, or can be small. For use on best effort packet networks such as the Internet, the buffer memory (215) may be required, can be comparatively large and can be advantageously of adaptive size, and may at least partially be implemented in an operating system or similar elements (not depicted) outside of the video decoder (210).

The video decoder (210) may include the parser (220) to reconstruct symbols (221) from the coded video sequence. Categories of those symbols include information used to manage operation of the video decoder (210), and potentially information to control a rendering device such as a render device (212) (e.g., a display screen) that is not an integral part of the electronic device (230) but can be coupled to the electronic device (230), as shown in FIG. 2. The control information for the rendering device(s) may be in the form of Supplemental Enhancement Information (SEI) messages or Video Usability Information (VUI) parameter set fragments (not depicted). The parser (220) may parse/entropy-decode the coded video sequence that is received. The coding of the coded video sequence can be in accordance with a video coding technology or standard, and can follow various principles, including variable length coding, Huffman coding, arithmetic coding with or without context sensitivity, and so forth. The parser (220) may extract from the coded video sequence, a set of subgroup parameters for at least one of the subgroups of pixels in the video decoder, based upon at least one parameter corresponding to the group. Subgroups can include Groups of Pictures (GOPs), pictures, tiles, slices, macroblocks, Coding Units (CUs), blocks, Transform Units (TUs), Prediction Units (PUs) and so forth. The parser (220) may also extract from the coded video sequence information such as transform coefficients, quantizer parameter values, motion vectors, and so forth.

The parser (220) may perform an entropy decoding/parsing operation on the video sequence received from the buffer memory (215), so as to create symbols (221).

Reconstruction of the symbols (221) can involve multiple different units depending on the type of the coded video picture or parts thereof (such as: inter and intra picture, inter and intra block), and other factors. Which units are involved, and how, can be controlled by subgroup control information parsed from the coded video sequence by the parser (220). The flow of such subgroup control information between the parser (220) and the multiple units below is not depicted for clarity.

Beyond the functional blocks already mentioned, the video decoder (210) can be conceptually subdivided into a number of functional units as described below. In a practical implementation operating under commercial constraints, many of these units interact closely with each other and can, at least partly, be integrated into each other. However, for the purpose of describing the disclosed subject matter, the conceptual subdivision into the functional units below is appropriate.

A first unit is the scaler/inverse transform unit (251). The scaler/inverse transform unit (251) receives a quantized transform coefficient as well as control information, including which transform to use, block size, quantization factor, quantization scaling matrices, etc. as symbol(s) (221) from the parser (220). The scaler/inverse transform unit (251) can output blocks comprising sample values, that can be input into aggregator (255).

In some cases, the output samples of the scaler/inverse transform unit (251) can pertain to an intra coded block. The intra coded block is a block that is not using predictive information from previously reconstructed pictures, but can use predictive information from previously reconstructed parts of the current picture. Such predictive information can be provided by an intra picture prediction unit (252). In some cases, the intra picture prediction unit (252) generates a block of the same size and shape of the block under reconstruction, using surrounding already reconstructed information fetched from the current picture buffer (258). The current picture buffer (258) buffers, for example, partly reconstructed current picture and/or fully reconstructed current picture. The aggregator (255), in some cases, adds, on a per sample basis, the prediction information the intra prediction unit (252) has generated to the output sample information as provided by the scaler/inverse transform unit (251).

In other cases, the output samples of the scaler/inverse transform unit (251) can pertain to an inter coded, and potentially motion compensated, block. In such a case, a motion compensation prediction unit (253) can access reference picture memory (257) to fetch samples used for prediction. After motion compensating the fetched samples in accordance with the symbols (221) pertaining to the block, these samples can be added by the aggregator (255) to the output of the scaler/inverse transform unit (251) (in this case called the residual samples or residual signal) so as to generate output sample information. The addresses within the reference picture memory (257) from where the motion compensation prediction unit (253) fetches prediction samples can be controlled by motion vectors, available to the motion compensation prediction unit (253) in the form of symbols (221) that can have, for example X, Y, and reference picture components. Motion compensation also can include interpolation of sample values as fetched from the reference picture memory (257) when sub-sample exact motion vectors are in use, motion vector prediction mechanisms, and so forth.

The output samples of the aggregator (255) can be subject to various loop filtering techniques in the loop filter unit (256). Video compression technologies can include in-loop filter technologies that are controlled by parameters included in the coded video sequence (also referred to as coded video bitstream) and made available to the loop filter unit (256) as symbols (221) from the parser (220). Video compression can also be responsive to meta-information obtained during the decoding of previous (in decoding order) parts of the coded picture or coded video sequence, as well as responsive to previously reconstructed and loop-filtered sample values.

The output of the loop filter unit (256) can be a sample stream that can be output to the render device (212) as well as stored in the reference picture memory (257) for use in future inter-picture prediction.

Certain coded pictures, once fully reconstructed, can be used as reference pictures for future prediction. For example, once a coded picture corresponding to a current picture is fully reconstructed and the coded picture has been identified as a reference picture (by, for example, the parser (220)), the current picture buffer (258) can become a part of the reference picture memory (257), and a fresh current picture buffer can be reallocated before commencing the reconstruction of the following coded picture.

The video decoder (210) may perform decoding operations according to a predetermined video compression technology or a standard, such as ITU-T Rec. H.265. The coded video sequence may conform to a syntax specified by the video compression technology or standard being used, in the sense that the coded video sequence adheres to both the syntax of the video compression technology or standard and the profiles as documented in the video compression technology or standard. Specifically, a profile can select certain tools as the only tools available for use under that profile from all the tools available in the video compression technology or standard. Also necessary for compliance can be that the complexity of the coded video sequence is within bounds as defined by the level of the video compression technology or standard. In some cases, levels restrict the maximum picture size, maximum frame rate, maximum reconstruction sample rate (measured in, for example megasamples per second), maximum reference picture size, and so on. Limits set by levels can, in some cases, be further restricted through Hypothetical Reference Decoder (HRD) specifications and metadata for HRD buffer management signaled in the coded video sequence.

In an aspect, the receiver (231) may receive additional (redundant) data with the encoded video. The additional data may be included as part of the coded video sequence(s). The additional data may be used by the video decoder (210) to properly decode the data and/or to more accurately reconstruct the original video data. Additional data can be in the form of, for example, temporal, spatial, or signal noise ratio (SNR) enhancement layers, redundant slices, redundant pictures, forward error correction codes, and so on.

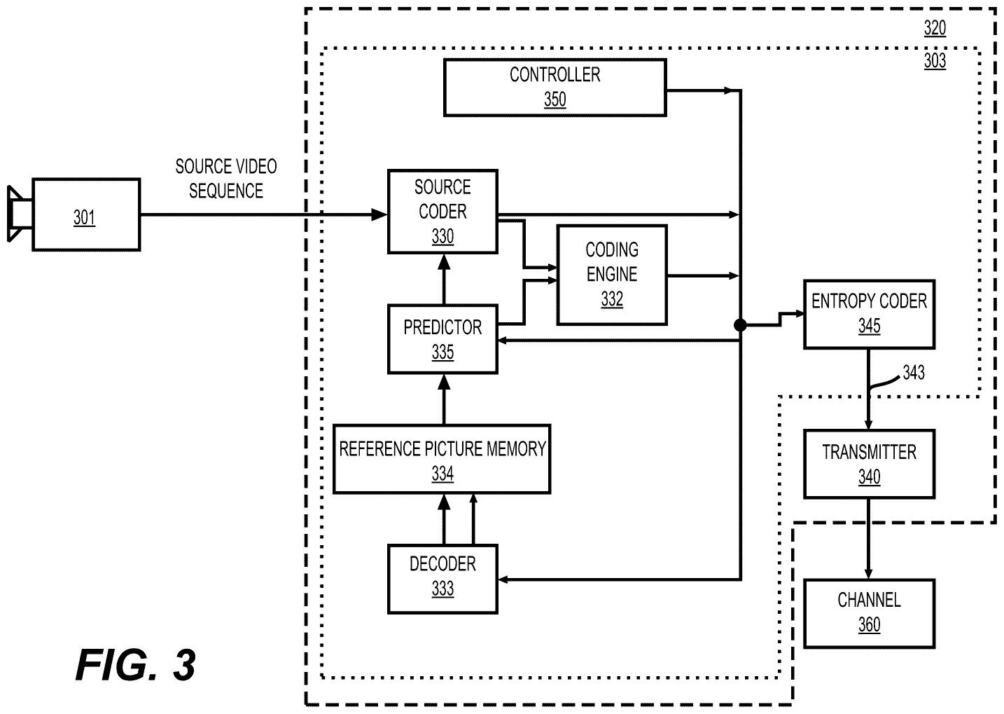

FIG. 3 shows an example of a block diagram of a video encoder (303). The video encoder (303) is included in an electronic device (320). The electronic device (320) includes a transmitter (340) (e.g., transmitting circuitry). The video encoder (303) can be used in the place of the video encoder (103) in the FIG. 1 example.

The video encoder (303) may receive video samples from a video source (301) (that is not part of the electronic device (320) in the FIG. 3 example) that may capture video image(s) to be coded by the video encoder (303). In another example, the video source (301) is a part of the electronic device (320).

The video source (301) may provide the source video sequence to be coded by the video encoder (303) in the form of a digital video sample stream that can be of any suitable bit depth (for example: 8 bit, 10 bit, 12 bit, . . . ), any colorspace (for example, BT.601 Y CrCB, RGB, . . . ), and any suitable sampling structure (for example Y CrCb 4:2:0, Y CrCb 4:4:4). In a media serving system, the video source (301) may be a storage device storing previously prepared video. In a videoconferencing system, the video source (301) may be a camera that captures local image information as a video sequence. Video data may be provided as a plurality of individual pictures that impart motion when viewed in sequence. The pictures themselves may be organized as a spatial array of pixels, wherein each pixel can comprise one or more samples depending on the sampling structure, color space, etc. in use. The description below focuses on samples.

According to an aspect, the video encoder (303) may code and compress the pictures of the source video sequence into a coded video sequence (343) in real time or under any other time constraints as required. Enforcing appropriate coding speed is one function of a controller (350). In some aspects, the controller (350) controls other functional units as described below and is functionally coupled to the other functional units. The coupling is not depicted for clarity. Parameters set by the controller (350) can include rate control related parameters (picture skip, quantizer, lambda value of rate-distortion optimization techniques, . . . ), picture size, group of pictures (GOP) layout, maximum motion vector search range, and so forth. The controller (350) can be configured to have other suitable functions that pertain to the video encoder (303) optimized for a certain system design.

In some aspects, the video encoder (303) is configured to operate in a coding loop. As an oversimplified description, in an example, the coding loop can include a source coder (330) (e.g., responsible for creating symbols, such as a symbol stream, based on an input picture to be coded, and a reference picture(s)), and a (local) decoder (333) embedded in the video encoder (303). The decoder (333) reconstructs the symbols to create the sample data in a similar manner as a (remote) decoder also would create. The reconstructed sample stream (sample data) is input to the reference picture memory (334). As the decoding of a symbol stream leads to bit-exact results independent of decoder location (local or remote), the content in the reference picture memory (334) is also bit exact between the local encoder and remote encoder. In other words, the prediction part of an encoder “sees” as reference picture samples exactly the same sample values as a decoder would “see” when using prediction during decoding. This fundamental principle of reference picture synchronicity (and resulting drift, if synchronicity cannot be maintained, for example because of channel errors) is used in some related arts as well.

The operation of the “local” decoder (333) can be the same as a “remote” decoder, such as the video decoder (210), which has already been described in detail above in conjunction with FIG. 2. Briefly referring also to FIG. 2, however, as symbols are available and encoding/decoding of symbols to a coded video sequence by an entropy coder (345) and the parser (220) can be lossless, the entropy decoding parts of the video decoder (210), including the buffer memory (215), and parser (220) may not be fully implemented in the local decoder (333).

In an aspect, a decoder technology except the parsing/entropy decoding that is present in a decoder is present, in an identical or a substantially identical functional form, in a corresponding encoder. Accordingly, the disclosed subject matter focuses on decoder operation. The description of encoder technologies can be abbreviated as they are the inverse of the comprehensively described decoder technologies. In certain areas a more detail description is provided below.

During operation, in some examples, the source coder (330) may perform motion compensated predictive coding, which codes an input picture predictively with reference to one or more previously coded picture from the video sequence that were designated as “reference pictures.” In this manner, the coding engine (332) codes differences between pixel blocks of an input picture and pixel blocks of reference picture(s) that may be selected as prediction reference(s) to the input picture.

The local video decoder (333) may decode coded video data of pictures that may be designated as reference pictures, based on symbols created by the source coder (330). Operations of the coding engine (332) may advantageously be lossy processes. When the coded video data may be decoded at a video decoder (not shown in FIG. 3), the reconstructed video sequence typically may be a replica of the source video sequence with some errors. The local video decoder (333) replicates decoding processes that may be performed by the video decoder on reference pictures and may cause reconstructed reference pictures to be stored in the reference picture memory (334). In this manner, the video encoder (303) may store copies of reconstructed reference pictures locally that have common content as the reconstructed reference pictures that will be obtained by a far-end video decoder (absent transmission errors).

The predictor (335) may perform prediction searches for the coding engine (332). That is, for a new picture to be coded, the predictor (335) may search the reference picture memory (334) for sample data (as candidate reference pixel blocks) or certain metadata such as reference picture motion vectors, block shapes, and so on, that may serve as an appropriate prediction reference for the new pictures. The predictor (335) may operate on a sample block-by-pixel block basis to find appropriate prediction references. In some cases, as determined by search results obtained by the predictor (335), an input picture may have prediction references drawn from multiple reference pictures stored in the reference picture memory (334).

The controller (350) may manage coding operations of the source coder (330), including, for example, setting of parameters and subgroup parameters used for encoding the video data.

Output of all aforementioned functional units may be subjected to entropy coding in the entropy coder (345). The entropy coder (345) translates the symbols as generated by the various functional units into a coded video sequence, by applying lossless compression to the symbols according to technologies such as Huffman coding, variable length coding, arithmetic coding, and so forth.

The transmitter (340) may buffer the coded video sequence(s) as created by the entropy coder (345) to prepare for transmission via a communication channel (360), which may be a hardware/software link to a storage device which would store the encoded video data. The transmitter (340) may merge coded video data from the video encoder (303) with other data to be transmitted, for example, coded audio data and/or ancillary data streams (sources not shown).

The controller (350) may manage operation of the video encoder (303). During coding, the controller (350) may assign to each coded picture a certain coded picture type, which may affect the coding techniques that may be applied to the respective picture. For example, pictures often may be assigned as one of the following picture types:

An Intra Picture (I picture) may be coded and decoded without using any other picture in the sequence as a source of prediction. Some video codecs allow for different types of intra pictures, including, for example Independent Decoder Refresh (“IDR”) Pictures.

A predictive picture (P picture) may be coded and decoded using intra prediction or inter prediction using a motion vector and reference index to predict the sample values of each block.

A bi-directionally predictive picture (B Picture) may be coded and decoded using intra prediction or inter prediction using two motion vectors and reference indices to predict the sample values of each block. Similarly, multiple-predictive pictures can use more than two reference pictures and associated metadata for the reconstruction of a single block.

Source pictures commonly may be subdivided spatially into a plurality of sample blocks (for example, blocks of 4×4, 8×8, 4×8, or 16×16 samples each) and coded on a block-by-block basis. Blocks may be coded predictively with reference to other (already coded) blocks as determined by the coding assignment applied to the blocks' respective pictures. For example, blocks of I pictures may be coded non-predictively or they may be coded predictively with reference to already coded blocks of the same picture (spatial prediction or intra prediction). Pixel blocks of P pictures may be coded predictively, via spatial prediction or via temporal prediction with reference to one previously coded reference picture. Blocks of B pictures may be coded predictively, via spatial prediction or via temporal prediction with reference to one or two previously coded reference pictures.

The video encoder (303) may perform coding operations according to a predetermined video coding technology or standard, such as ITU-T Rec. H.265. In its operation, the video encoder (303) may perform various compression operations, including predictive coding operations that exploit temporal and spatial redundancies in the input video sequence. The coded video data, therefore, may conform to a syntax specified by the video coding technology or standard being used.

In an aspect, the transmitter (340) may transmit additional data with the encoded video. The source coder (330) may include such data as part of the coded video sequence. Additional data may comprise temporal/spatial/SNR enhancement layers, other forms of redundant data such as redundant pictures and slices, SEI messages, VUI parameter set fragments, and so on.

A video may be captured as a plurality of source pictures (video pictures) in a temporal sequence. Intra-picture prediction (often abbreviated to intra prediction) makes use of spatial correlation in a given picture, and inter-picture prediction makes uses of the (temporal or other) correlation between the pictures. In an example, a specific picture under encoding/decoding, which is referred to as a current picture, is partitioned into blocks. When a block in the current picture is similar to a reference block in a previously coded and still buffered reference picture in the video, the block in the current picture can be coded by a vector that is referred to as a motion vector. The motion vector points to the reference block in the reference picture, and can have a third dimension identifying the reference picture, in case multiple reference pictures are in use.

In some examples, a bi-prediction technique can be used in the inter-picture prediction. According to the bi-prediction technique, two reference pictures, such as a first reference picture and a second reference picture that are both prior in decoding order to the current picture in the video (but may be in the past and future, respectively, in display order) are used. A block in the current picture can be coded by a first motion vector that points to a first reference block in the first reference picture, and a second motion vector that points to a second reference block in the second reference picture. The block can be predicted by a combination of the first reference block and the second reference block.

Further, a merge mode technique can be used in the inter-picture prediction to improve coding efficiency.

According to some aspects of the disclosure, predictions, such as inter-picture predictions and intra-picture predictions, are performed in the unit of blocks. For example, according to the HEVC standard, a picture in a sequence of video pictures is partitioned into coding tree units (CTU) for compression, the CTUs in a picture have the same size, such as 64×64 pixels, 32×32 pixels, or 16×16 pixels. In general, a CTU includes three coding tree blocks (CTBs), which are one luma CTB and two chroma CTBs. Each CTU can be recursively quadtree split into one or multiple coding units (CUs). For example, a CTU of 64×64 pixels can be split into one CU of 64×64 pixels, or 4 CUs of 32×32 pixels, or 16 CUs of 16×16 pixels. In an example, each CU is analyzed to determine a prediction type for the CU, such as an inter prediction type or an intra prediction type. The CU is split into one or more prediction units (PUs) depending on the temporal and/or spatial predictability. Generally, each PU includes a luma prediction block (PB), and two chroma PBs. In an aspect, a prediction operation in coding (encoding/decoding) is performed in the unit of a prediction block. Using a luma prediction block as an example of a prediction block, the prediction block includes a matrix of values (e.g., luma values) for pixels, such as 8×8 pixels, 16×16 pixels, 8×16 pixels, 16×8 pixels, and the like.

It is noted that the video encoders (103) and (303), and the video decoders (110) and (210) can be implemented using any suitable technique. In an aspect, the video encoders (103) and (303) and the video decoders (110) and (210) can be implemented using one or more integrated circuits. In another aspect, the video encoders (103) and (303), and the video decoders (110) and (210) can be implemented using one or more processors that execute software instructions.

Aspects of the disclosure provide techniques for decoder side quantization shifting offset prediction. The techniques are used for determining the quantization shifting offset at the decoder side for image and video coding in some examples, and can achieve image quality improvement.

In video codec, techniques, such as transform, quantization, and the like are used to reduce redundancy in video signals. For example, transform techniques can reduce redundancy in the video signal by decorrelation, and quantization techniques can decrease the data of the transform coefficient representation by reducing precision, for example by removing imperceptible details, and thus reducing irrelevance in the data.

In some examples, transformation decorrelates a signal by transforming the signal from the spatial domain to a transform domain (e.g., a frequency domain), using a suitable transform basis. For example, a transform is applied to the prediction residual (regardless of whether it comes from inter- or intra-picture prediction), that is, the difference between the prediction and the original input video signal. In the transform domain, the essential information typically concentrates into a small number of coefficients. At the decoder, the inverse transform can be applied to reconstruct the residual samples.

Generally, quantization is used to reduce the precision of an input value or a set of input values in order to decrease the amount of data needed to represent the values. In some examples, the quantization is typically applied to individual transformed residual samples (e.g., transform coefficients), resulting in integer coefficient levels. The transform process is applied at the encoder. At the decoder, the corresponding process is known as inverse quantization (also referred to as dequantization), which restores the original value range without regaining the precision.

In some related video and image codecs, a quantization shifting offset ρ* that is predefined can be applied on the dequantized values at the decoder side. In some examples, the quantization shifting offset ρ* can be used to control a quantization dead zone.

In some related examples, at the decoder side, the reconstructed transform coefficient value y, is generated by shifting the dequantized values dqᵢ (e.g., result from inverse quantization) within a dequantized block (in the transform domain also referred to as frequency domain) with the predefined quantization shifting offset ρ*, such as according to Eq. (1):

$$\{ \begin{matrix}{y}_{i} ← {dq}_{i} + {ρ}^{*} & when {dq}_{i} > 0 \\ {y}_{i} ← {dq}_{i} - {ρ}^{*} & when {dq}_{i} < 0 \\ {y}_{i} ← {dq}_{i} & when {dq}_{i} = 0\end{matrix} , for i = 1 .. n \qquad Eq . ( 1 )$$

In some examples, (e.g., HEVC, VVC and the like), frequency specific quantization scaling is allowed. The frequency specific quantization of the transform coefficients can be implemented by providing scaling list to the coder (encoder/decoder). For example, human visual system is less sensitive to high spatial frequency in visual content. High frequencies can be quantized more coarsely to save bitrate while keeping similar visual quality. In some examples, an initial uniform quantization step is derived according to a quantization parameter, and then a scaling matrix with scaling factors for different frequencies can be used with the uniform initial quantization step to define specific quantization for each frequency coefficients. In an example, a scaling factor that is larger than 0 and smaller than 16 can result in a smaller quantization interval than the initial uniform quantization step; and a scaling factor that is larger than 16 can result in a coarser quantization step size than the initial uniform quantization step. In some examples, encoder/decoder can use a scaling list of multiple scaling matrices for different prediction modes, block size, or color components.

In some examples, scaling factors can be a fixed value for all transform coefficients within the same block. In some examples, scaling factors can have varying values depending on the frequency associated with a specific transform coefficient.

According to some aspects of the disclosure, the quantization shifting offset ρ* is affected by quantization and/or dequantization. In some examples, when the quantization shifting offset ρ* is adaptively adjusted according to what happened during the quantization and/or dequantization, compression efficiency can be improved. The present disclosure provides techniques for adaptive shifting offset for quantizer center shifting (also referred to as quantization shifting offset), and the techniques can improve the compression efficiency. In some examples, encoder/decoder can determine one or more quantization shifting offsets for a reconstruction of transform coefficients in the transform domain based on at least a scaling factor. The encoder/decoder can reconstruct the transform coefficients from the quantized transform coefficients based on the one or more quantization shifting offsets, calculate residuals in a spatial domain of the current block based on the transform coefficients in the transform domain and reconstruct the current block according to the residuals in the spatial domain. In some examples, the encoder can derive the one or more quantization shifting offsets during quantization or dequantization process and signal the one or more quantization shifting offsets in the bitstream to the decoder side.

According to an aspect of the disclosure, the shifting offset value ρ* is depending on the parameters that may affect the quantization/dequantization of a block, such as scaling factor, scaling list or any other parameter related to quantization/dequantization of the block. The quantization shifting offset ρ* is determined adaptively based on at least a scaling factor.

In some embodiments, a quantization shifting offset of a block is a single value calculated depending on the scaling factor of the block.

In an example, the scaling factor of the block is a single value s, and the quantization shifting offset ρ* is calculated as in Eq. (2):

$${ρ}^{*} = a \cdot s + b \qquad Eq . ( 2 )$$

where a and b are some predefined constants.

In another example, the scaling factor of the block is a single value s, and the shifting offset ρ* is calculated as in Eq. (3):

$${ρ}^{*} = f ( s ) \qquad Eq . ( 3 )$$

where f is some predefined function.

In another example, the scaling factors of an n×n block are in the form of an n×n scaling matrix, and the quantization shifting offset ρ* of the block is calculated based on a combination, such as an average value of the scaling factors of the n×n block, such as in Eq. (4):

$${ρ}^{*} = a \cdot \frac{{\sum }_{i = 0}^{{n}^{2} - 1} {s}_{i}}{{n}^{2}} + b \qquad Eq . ( 4 )$$

where a and b are some predefined constants, sᵢ denotes a scaling vector in the scaling matrix, i denotes an index associated with a position in the scaling matrix.

In another example, the scaling factors of an n×n block are in the form of an n×n scaling matrix, and the quantization shifting offset ρ* is calculated based on a combination of the scaling factors of the n×n block, such as a sum of the scaling factors of the n×n block as in Eq. (5):

$${ρ}^{*} = f ( {\sum }_{i = 0}^{{n}^{2} - 1} {s}_{i} ) \qquad Eq . ( 5 )$$

where f is some predefined function, sᵢ denotes a scaling vector in the scaling matrix, i denotes an index associated with a position in the scaling matrix.

In some embodiments, the quantization shifting offset values are position dependent based on the scaling factor value at the position (also referred to as coefficient position, and is associated with a frequency). In some examples, a lookup table can be used to obtain the quantization shifting offset value according to the coefficient position in a block. For example, the lookup table includes quantization shifting offset values that are indexed based on coefficient positions in the block.

In an example, the scaling factor of the block is a single value s, and the quantization shifting offset at a (coefficient) position i of the block ρ*(i) can be calculated according to a function of the position, such as using Eq. (6):

$${ρ}^{*} ( i ) = a \cdot s \cdot i + b \qquad Eq . ( 6 )$$

where a and b are predefined constants, i denotes an index associated with a position (e.g., coefficient position). It is noted that other suitable function of the (coefficient) position i can be used to represent the relationship of the quantitation shifting offset values with the coefficient positions.

In another example, the scaling factor of the block is a single value s, and the quantization shifting offset at each (coefficient) position i of the block ρ*(i) can be calculated according to Eq. (7):

$${ρ}^{*} ( i ) = {f}_{i} ( s ) \qquad Eq . ( 7 )$$

where fᵢ is some predefined function. For positions, different functions can be used.

In another example, the scaling factors of an n×n block are in the form of an n×n scaling matrix, positions of the block respectively correspond to positions of the scaling matrix, and the quantization shifting offset at each (coefficient) position i of the block ρ*(i) is calculated based on the value of the scaling factor at the position i, such as according to Eq. (8):

$${ρ}^{*} ( i ) = a \cdot s ( i ) + b \qquad Eq . ( 8 )$$

where a and b are some predefined constants, i denotes an index associated with a position in the scaling matrix, s(i) denotes the scaling factor value at the position i.

In another example, the scaling factors of an n×n block are in the form of an n×n scaling matrix, and the quantization shifting offset at each (coefficient) position i of the block ρ*(i) is calculated based on the value of the scaling factor at the position i, such as according to Eq. (9)

$${ρ}^{*} ( i ) = f ( s ( i ) ) \qquad Eq . ( 9 )$$

where f is some predefined function, i denotes an index associated with a position in the scaling matrix, i denotes an index associated with a position in the scaling matrix, s(i) denotes the scaling factor value at the position.

According to another aspect of the disclosure, the quantization shifting offset value(s) is derived at the quantization and/or dequantization process at the encoder side. The quantization shifting offset value(s) ρ* is signaled in the bitstream and used for the reconstruction process at the decoder side.

In some embodiments, the quantization shifting offset values are signaled in the bitstream for the whole sequence/picture/slice/tile. For example, the quantization shifting offset values can be signaled and derived from a high level parameter set, such as sequence parameter set, picture parameter set, slice header, tile header and the like. In an example, one or more additional syntax elements can be used to represent the quantization shifting offset value(s) in the bitstream.

In some embodiments, the quantization shifting offset value(s) is(are) signaled in the bitstream for each block. For example, the quantization shifting offset value(s) is(are) signaled and derived for each block. In an example, one or more additional syntax elements can be used to represent the quantization shifting offset value(s) in the bitstream.

In some embodiments, the quantization shifting offset value(s) is(are) signaled in the bitstream for each or for some subset of the transform coefficients. For example, the quantization shifting offset value(s) is(are) signaled and derived at the transform coefficient level (for each of transform coefficients, or one or more subsets of transform coefficients). In an example, one or more additional syntax elements can be used to represent the quantization shifting offset value(s) in the bitstream.

In some embodiments, the quantization shifting offset value(s) can be signaled in addition to the scaling factor in the bitstream at sequence/picture/slice/tile/block/coefficient etc. level and can use one or more additional syntax elements to represent the shifting offset value in the bitstream. For example, the quantization shifting offset value(s) can be signaled in combination with the scaling factor in the bitstream at various syntax level, such as sequence level (sequence parameter set), picture level (picture parameter set), slice level (e.g., in slice header), tile level (e.g., in tile header), block level, transform coefficient level and the like. In some examples, one or more additional syntax elements can be used to represent the quantization shifting offset value in the bitstream.

In some examples, an index is signaled in the bitstream indicating one quantization shifting offset value and one scaling factor value for a sequence, a picture, a slice, a tile, a block, a transform coefficient, a subset of transform coefficients, and the like. In an example, an index can indicate a combination of a quantization shifting offset value and a scaling factor value.

In some examples, an index is signaled in the bitstream indicating one quantization shifting offset value and one scaling factor lookup table for a sequence, a picture, a slice, a tile, a block, a transform coefficient, a subset of transform coefficients, and the like. In an example, an index can indicate a quantization shifting offset value, and an entry in a lookup table of values for the scaling factor. The entry includes a scaling factor value. In another example, index can indicate a quantization shifting offset value and a lookup table from a plurality of lookup tables for the scaling factor.

In some examples, an index is signaled in the bitstream indicating one shifting offset lookup table and one scaling factor lookup table for a sequence, a picture, a slice, a tile, a block, a transform coefficient, a subset of transform coefficients, and the like. In an example, the index can indicate a first lookup table from a plurality of first lookup tables for the quantization shifting offset, and a second lookup table from a plurality of second lookup tables for the scaling factor.

In some embodiments, different quantization shifting offset values are signaled for different color components. In an example, a first quantization shifting offset value is signaled for luma component of a block and a second quantization shifting offset value is signaled for chroma components of the block.

According to another aspect of the disclosure, the sign of shifting offset is derived at the quantization process or dequantization process at the encoder side. The sign is signaled in the bitstream and can be used for the reconstruction process at the decoder side.

In some embodiments, the sign of the quantization shifting offsets is signaled in the bitstream for the whole sequence/picture/slice/tile/etc. parameter set and can use one or more additional syntax elements to represent the sign in the bitstream. For example, the sign of the quantization shifting offset values can be signaled and derived from a high level parameter set, such as sequence parameter set, picture parameter set, slice header, tile header and the like. In an example, one or more additional syntax elements can be used to represent the sign of quantization shifting offset value(s) in the bitstream.

In some embodiments, the sign of the quantization shifting offsets is signaled in the bitstream for each block. For example, the quantization shifting offsets are derived for each block and one or more additional syntax elements can be used to represent the sign in the bitstream.

In some embodiments, the sign of the quantization shifting offsets is signaled in the bitstream for each or for one or more subsets of the transform coefficients. In an example, the quantization shifting offsets are derived for each individual transform coefficient and one or more additional syntax elements can be used to represent the sign in the bitstream.

In some embodiments, the sign of the quantization shifting offset is signaled in addition to (e.g., in combination with) the scaling factor in the bitstream at various syntax level, such as at sequence level (e.g., in sequence parameter set), at picture level (e.g., in picture parameter set), at slice level (e.g., in slice header), at tile level (e.g., in tile header), at block level, and the like, one or more additional syntax elements can be used to represent the sign in the bitstream.

In an example, an index is signaled in the bitstream, and indicates the sign of the quantization shifting offset and the scaling factor value for a sequence, a picture, a slice, a tile, a block, a transform coefficient, and the like.

In another example, an index is signaled in the bitstream, and indicates the sign of the shifting offset and an entry in a scaling factor lookup table for a sequence, a picture, a slice, a tile, a block, a transform coefficient, and the like. In another example, an index is signaled in the bitstream, and indicates the sign of the shifting offset and a scaling factor lookup table for a sequence, a picture, a slice, a tile, a block, a transform coefficient, and the like. The scaling factor lookup table can be used to determine the scaling factor based on other suitable information.

According to another aspect of the disclosure, the shifting offset value ρ* is derived based on the coded information at the decoder side.

In some embodiments, the quantization shifting offset of the current transform coefficient or current block is derived based on the value of neighboring levels, coded transform coefficients, block size/shape, and the like.

In some embodiments, the quantization shifting offset value of the transform coefficient or current block is derived by minimizing the discontinuity of the reconstructed block boundaries between current block and the neighboring already reconstructed blocks. In an example, the discontinuity is measured by the absolute difference between the boundary samples located inside the current block and the neighboring block.

In some embodiments, the quantization shifting offset value may be color component dependent, that is, the derivation of quantization shifting offset can be different among different color components. The derivation of shifting offset refers to any function or process or parameters that is involved for calculating the shifting offset values.

According to an aspect of the disclosure, the sign of the shifting offset ρ* is derived at the reconstruction process based on the existing information at the decoder side.

In some embodiments, the sign of the shifting offset of the current transform coefficient/block is derived based on the value of neighboring levels, block size and/or block shape, and the like.

In some embodiments, the sign of the shifting offset of the transform coefficient/block is derived by minimizing the discontinuity of the reconstructed block boundaries between current block and the neighboring already reconstructed blocks.

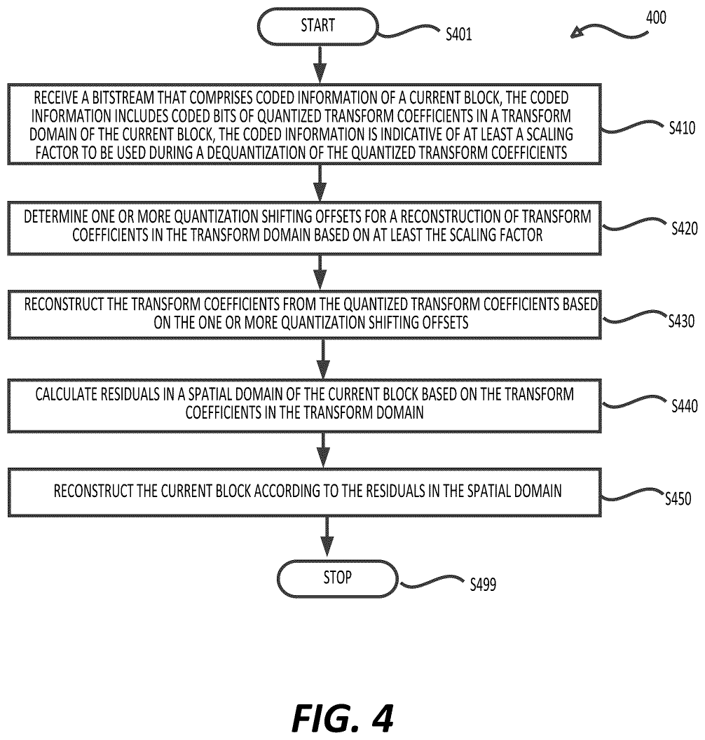

FIG. 4 shows a flow chart outlining a process (400) according to an aspect of the disclosure. The process (400) can be used in a video decoder. In various aspects, the process (400) is executed by processing circuitry, such as the processing circuitry that performs functions of the video decoder (110), the processing circuitry that performs functions of the video decoder (210), and the like. In some aspects, the process (400) is implemented in software instructions, thus when the processing circuitry executes the software instructions, the processing circuitry performs the process (400). The process starts at (S401) and proceeds to (S410).

At (S410), a bitstream that includes coded information of a current block is received. The coded information of the current block includes coded bits of quantized transform coefficients in a transform domain of the current block, the coded information is also indicative of at least a scaling factor to be used during a dequantization of the quantized transform coefficients.

At (S420), one or more quantization shifting offsets for a reconstruction of transform coefficients in the transform domain are determined based on at least the scaling factor.

At (S430), the transform coefficients are reconstructed from the quantized transform coefficients based on the one or more quantization shifting offsets.

At (S440), residuals in a spatial domain of the current block are calculated based on the transform coefficients in the transform domain.

At (S450), the current block is reconstructed according to the residuals in the spatial domain.

According to some aspects of the disclosure, a single quantization shifting offset value is determined for the transform coefficients. In some examples, at least the scaling factor include a single scaling factor value for the transform coefficients associated with positions in the transform domain of the current block. In an example, the single quantization shifting offset value is determined according to a linear function (e.g., Eq. (2)) of the single scaling factor value, parameters of the linear function are predefined constants. In another example, the single quantization shifting offset value is determined according to a predefined function (e.g., Eq. (3)) of the single scaling factor value, the predefined function can be any suitable function.

In some examples, at least the scaling factor include scaling factor values respectively for the transform coefficients at respective positions in the transform domain of the current block. In an example, the single quantization shifting offset value is determined according to a linear function (e.g., Eq. (4)) of a combination of the scaling factor values, parameters of the linear function are predefined constants. In another example, the single quantization shifting offset value is determined according to a predefined function (e.g., Eq. (5)) of a combination of the scaling factor values.

According to some aspects of the disclosure, respective quantization shifting offset values for the transform coefficients at respective positions in the transform domain of the current block are determined.

In some examples, at least the scaling factor include a single scaling factor value for the transform coefficients associated with positions in the transform domain of the current block. In an example, a first quantization shifting offset value for a first transform coefficient at a first position in the transform domain of the current block is determined according to a linear function (e.g., Eq. (6)) of the single scaling factor value with the first position, parameters of the linear function are predefined constants. In another example, the first quantization shifting offset value according to a first predefined function (e.g., Eq. (7)) of the single scaling factor value. The first predefined function is associated with the first position, different predefined functions can be defined to be associated with different positions of the transform coefficients in the transform domain.

In some examples, at least the scaling factor include respective scaling factor values for the transform coefficients at respective positions in the transform domain of the current block. In an example, a first quantization shifting offset value for a first transform coefficient at a first position in the transform domain of the current block is determined according to a linear function (e.g., Eq. (8)) of a first scaling factor at the first position, parameters of the linear function are predefined constants. In another example, the first quantization shifting offset value for the first transform coefficient at the first position in the transform domain of the current block is determined according to a predefined function (e.g., Eq. (9)) of the first scaling factor at the first position.

Then, the process proceeds to (S499) and terminates.

The process (400) can be suitably adapted. Step(s) in the process (400) can be modified and/or omitted. Additional step(s) can be added. Any suitable order of implementation can be used.

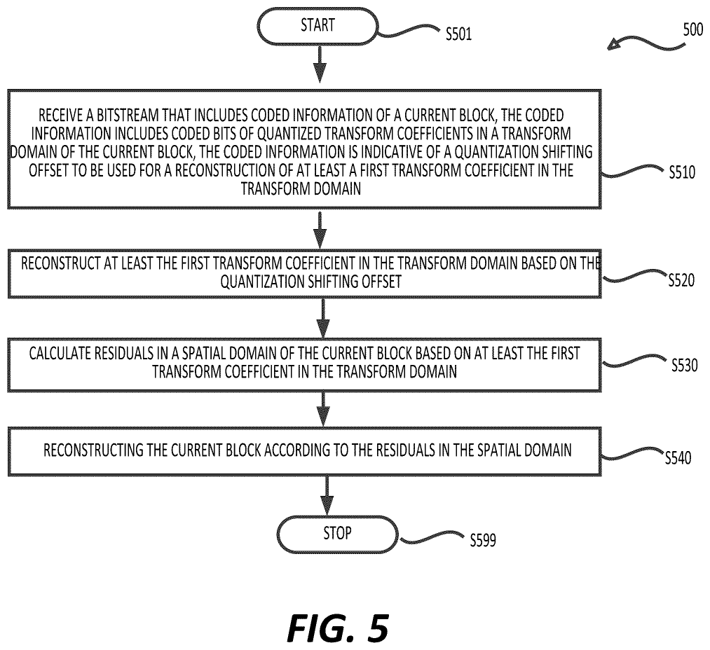

FIG. 5 shows a flow chart outlining a process (500) according to an aspect of the disclosure. The process (500) can be used in a video decoder. In various aspects, the process (500) is executed by processing circuitry, such as the processing circuitry that performs functions of the video decoder (110), the processing circuitry that performs functions of the video decoder (210), and the like. In some aspects, the process (500) is implemented in software instructions, thus when the processing circuitry executes the software instructions, the processing circuitry performs the process (500). The process starts at (S501) and proceeds to (S510).

At (S510), a bitstream that includes coded information of a current block is received. The coded information of the current block includes coded bits of quantized transform coefficients in a transform domain of the current block. The coded information is also indicative of a quantization shifting offset to be used for a reconstruction of at least a first transform coefficient in the transform domain.

At (S520), at least the first transform coefficient in the transform domain is reconstructed based on the quantization shifting offset.

At (S530), residuals in a spatial domain of the current block is calculated based on at least the first transform coefficient in the transform domain.

At (S540), the current block is reconstructed according to the residuals in the spatial domain.

According to an aspect of the disclosure, one or more syntax elements from a high level syntax are decoded, the one or more syntax elements indicates a value of the quantization shifting offset for a video portion associated with the high level syntax or a sign of the quantization shifting offset for the video portion associated with the high level syntax. The high level syntax includes at least one of a sequence level syntax (e.g., in sequence parameter set), a picture level syntax (e.g., in picture parameter set), a slice level syntax (e.g., in slice header) and a tile level syntax (e.g., in tile header).

According to another aspect of the disclosure, one or more syntax elements of the current block (e.g., at block level) are decoded. The one or more syntax elements indicate a value of the quantization shifting offset of the current block or a sign of the quantization shifting offset of the current block.

According to another aspect of the disclosure, one or more syntax elements of the current block (e.g., at transform coefficient level or at a subset of transform coefficients level) are decoded. The one or more syntax elements indicate a value of the quantization shifting offset for a subset of transform coefficients in the transform domain of the current block or a sign of the quantization shifting offset for the subset of transform coefficients. The subset of transform coefficients includes the first transform coefficient.

According to another aspect of the disclosure, the coded information includes one or more syntax elements that indicates a combination of the quantization shifting offset and a scaling factor to be used during a dequantization of the quantized transform coefficients.

In an example, the one or more syntax elements include an index indicating a combination of a first value of the quantization shifting offset and a second value of the scaling factor for a coding unit, such as a sequence of pictures, a picture, a slice, a tile, a block, a subset of transform coefficients, a transform coefficient and the like.

In another example, the one or more syntax elements include an index indicating a combination of the quantization shifting offset and a lookup table for the scaling factor for a coding unit, such as a sequence of pictures, a picture, a slice, a tile, a block, a subset of transform coefficients, a transform coefficient and the like. For example, multiple lookup tables can be used for the scaling factor. The index can indicate one of the multiple lookup tables for the coding unit, and other suitable factors can be used to determine which entry in the lookup table is used for the value of the scaling factor.

In another example, the one or more syntax elements include an index indicating a combination of a first lookup table for the quantization shifting offset and a second lookup table for the scaling factor for a coding unit, such as a sequence of pictures, a picture, a slice, a tile, a block, a subset of transform coefficients, a transform coefficient and the like. For example, multiple first lookup tables can be used for the quantization shifting offset, and multiple second lookup tables can be used for the scaling factor. The index can indicate one of the first multiple lookup tables and one of the second multiple lookup tables for the coding unit, and other suitable factors can be used to determine which entry in the first lookup table is used for determining the value of the quantization shifting offset and which entry in the second lookup table is used for determining the value of the scaling factor.

According to another aspect, the coded information is indicative of a first quantization shifting offset to be used for a first color component and a second quantization shifting offset to be used for a second color component.

Then, the process proceeds to (S599) and terminates.

The process (500) can be suitably adapted. Step(s) in the process (500) can be modified and/or omitted. Additional step(s) can be added. Any suitable order of implementation can be used.

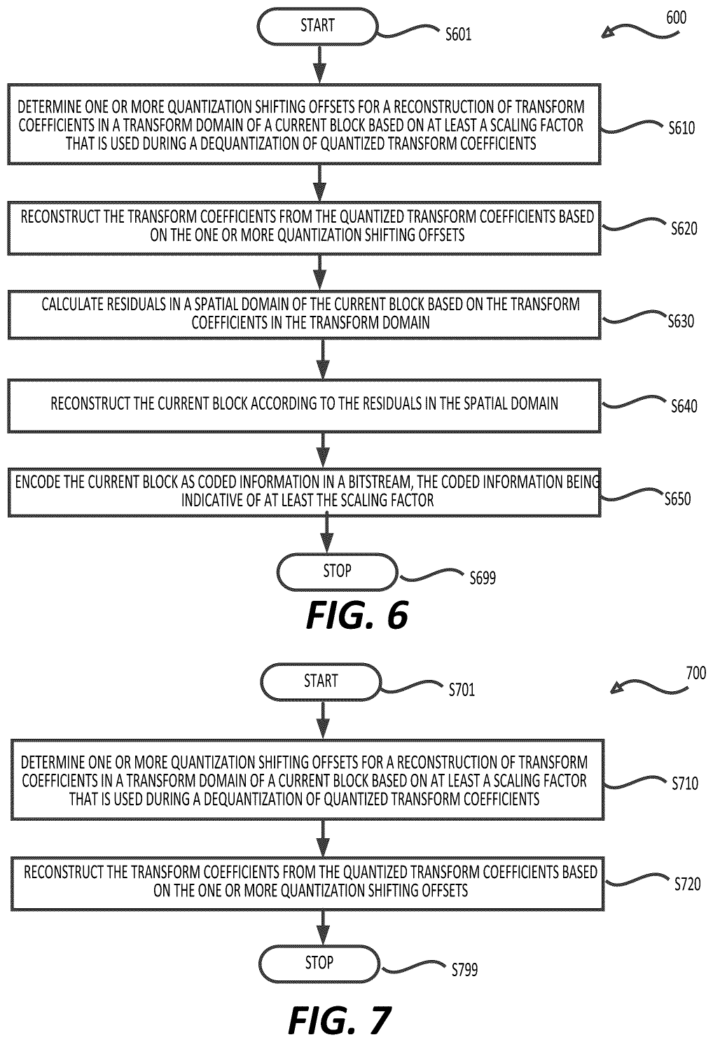

FIG. 6 shows a flow chart outlining a process (600) according to an aspect of the disclosure. The process (600) can be used in a video encoder. In various aspects, the process (600) is executed by processing circuitry, such as the processing circuitry that performs functions of the video encoder (103), the processing circuitry that performs functions of the video encoder (303), and the like. In some examples, the process (600) is implemented in software instructions, thus when the processing circuitry executes the software instructions, the processing circuitry performs the process (600). The process starts at (S601) and proceeds to (S610).

At (S610), one or more quantization shifting offsets for a reconstruction of transform coefficients in a transform domain of a current block are determined based on at least a scaling factor that is used during a dequantization of quantized transform coefficients.

At (S620), the transform coefficients are reconstructed from the quantized transform coefficients based on the one or more quantization shifting offsets.

At (S630), residuals in a spatial domain of the current block are calculated based on the transform coefficients in the transform domain.

At (S640), the current block is reconstructed according to the residuals in the spatial domain.

At (S650), the current block is encoded as coded information in a bitstream, the coded information is indicative of at least the scaling factor.

According to some aspects of the disclosure, a single quantization shifting offset value is determined for the transform coefficients. In some examples, at least the scaling factor include a single scaling factor value for the transform coefficients associated with positions in the transform domain of the current block. In an example, the single quantization shifting offset value is determined according to a linear function (e.g., Eq. (2)) of the single scaling factor value, parameters of the linear function are predefined constants. In another example, the single quantization shifting offset value is determined according to a predefined function (e.g., Eq. (3)) of the single scaling factor value, the predefined function can be any suitable function.

In some examples, at least the scaling factor include scaling factor values respectively for the transform coefficients at respective positions in the transform domain of the current block. In an example, the single quantization shifting offset value is determined according to a linear function (e.g., Eq. (4)) of a combination of the scaling factor values, parameters of the linear function are predefined constants. In another example, the single quantization shifting offset value is determined according to a predefined function (e.g., Eq. (5)) of a combination of the scaling factor values.

According to some aspects of the disclosure, respective quantization shifting offset values for the transform coefficients at respective positions in the transform domain of the current block are determined.

In some examples, at least the scaling factor include a single scaling factor value for the transform coefficients associated with positions in the transform domain of the current block. In an example, a first quantization shifting offset value for a first transform coefficient at a first position in the transform domain of the current block is determined according to a linear function (e.g., Eq. (6)) of the single scaling factor value with the first position, parameters of the linear function are predefined constants. In another example, the first quantization shifting offset value according to a first predefined function (e.g., Eq. (7)) of the single scaling factor value. The first predefined function is associated with the first position, different predefined functions can be defined to be associated with different positions of the transform coefficients in the transform domain.

In some examples, at least the scaling factor include respective scaling factor values for the transform coefficients at respective positions in the transform domain of the current block. In an example, a first quantization shifting offset value for a first transform coefficient at a first position in the transform domain of the current block is determined according to a linear function (e.g., Eq. (8)) of a first scaling factor at the first position, parameters of the linear function are predefined constants. In another example, the first quantization shifting offset value for the first transform coefficient at the first position in the transform domain of the current block is determined according to a predefined function (e.g., Eq. (9)) of the first scaling factor at the first position.

Then, the process proceeds to (S699) and terminates.

The process (600) can be suitably adapted. Step(s) in the process (600) can be modified and/or omitted. Additional step(s) can be added. Any suitable order of implementation can be used.

FIG. 7 shows a flow chart outlining a process (700) according to an aspect of the disclosure. The process (700) can be used in a video encoder. In various aspects, the process (700) is executed by processing circuitry, such as the processing circuitry that performs functions of the video encoder (103), the processing circuitry that performs functions of the video encoder (303), and the like. In some examples, the process (700) is implemented in software instructions, thus when the processing circuitry executes the software instructions, the processing circuitry performs the process (700). The process starts at (S701) and proceeds to (S710).

At (S710), a quantization shifting offset for a reconstruction of at least a first transform coefficient in a transform domain of a current block from quantized transform coefficients is derived.

At (S720), the current block is encoded as coded information in a bitstream, the coded information is indicative of the quantization shifting offset.

According to an aspect of the disclosure, the coded information includes one or more syntax elements of a high level syntax, the one or more syntax elements indicates a value of the quantization shifting offset for a video portion associated with the high level syntax or a sign of the quantization shifting offset for the video portion associated with the high level syntax. The high level syntax includes at least one of a sequence level syntax (e.g., in sequence parameter set), a picture level syntax (e.g., in picture parameter set), a slice level syntax (e.g., in slice header) and a tile level syntax (e.g., in tile header).

According to another aspect of the disclosure, the coded information includes one or more syntax elements of the current block (e.g., at block level). The one or more syntax elements indicate a value of the quantization shifting offset of the current block or a sign of the quantization shifting offset of the current block.

According to another aspect of the disclosure, the coded information includes one or more syntax elements of the current block (e.g., at transform coefficient level or at a subset of transform coefficients level). The one or more syntax elements indicate a value of the quantization shifting offset for a subset of transform coefficients in the transform domain of the current block or a sign of the quantization shifting offset for the subset of transform coefficients. The subset of transform coefficients includes the first transform coefficient.

According to another aspect of the disclosure, the coded information includes one or more syntax elements that indicates a combination of the quantization shifting offset and a scaling factor to be used during a dequantization of the quantized transform coefficients.

In an example, the one or more syntax elements include an index indicating a combination of a first value of the quantization shifting offset and a second value of the scaling factor for a coding unit, such as a sequence of pictures, a picture, a slice, a tile, a block, a subset of transform coefficients, a transform coefficient and the like.

In another example, the one or more syntax elements include an index indicating a combination of the quantization shifting offset and a lookup table for the scaling factor for a coding unit, such as a sequence of pictures, a picture, a slice, a tile, a block, a subset of transform coefficients, a transform coefficient and the like. For example, multiple lookup tables can be used for the scaling factor. The index can indicate one of the multiple lookup tables for the coding unit, and other suitable factors can be used to determine which entry in the lookup table is used for the value of the scaling factor.

In another example, the one or more syntax elements include an index indicating a combination of a first lookup table for the quantization shifting offset and a second lookup table for the scaling factor for a coding unit, such as a sequence of pictures, a picture, a slice, a tile, a block, a subset of transform coefficients, a transform coefficient and the like. For example, multiple first lookup tables can be used for the quantization shifting offset, and multiple second lookup tables can be used for the scaling factor. The index can indicate one of the first multiple lookup tables and one of the second multiple lookup tables for the coding unit, and other suitable factors can be used to determine which entry in the first lookup table is used for determining the value of the quantization shifting offset and which entry in the second lookup table is used for determining the value of the scaling factor.

According to another aspect, the coded information is indicative of a first quantization shifting offset to be used for a first color component and a second quantization shifting offset to be used for a second color component.

Then, the process proceeds to (S799) and terminates.

The process (700) can be suitably adapted. Step(s) in the process (700) can be modified and/or omitted. Additional step(s) can be added. Any suitable order of implementation can be used.

According to an aspect of the disclosure, a method of processing visual media data is provided. In the method, a bitstream of visual media data is processed according to a format rule. For example, the bitstream may be a bitstream that is decoded/encoded in any of the decoding and/or encoding methods described herein. The format rule may specify one or more constraints of the bitstream and/or one or more processes to be performed by the decoder and/or encoder.

In an example, the bitstream includes coded information of a current block, the coded information of the current block includes coded bits of quantized transform coefficients in a transform domain of the current block, the coded information is indicative of at least a scaling factor to be used during a dequantization of the quantized transform coefficients. The format rule specifies that one or more quantization shifting offsets for a reconstruction of transform coefficients in the transform domain are determined based on at least the scaling factor, the transform coefficients are reconstructed from the quantized transform coefficients based on the one or more quantization shifting offsets, residuals in a spatial domain of the current block are calculated based on the transform coefficients in the transform domain, and the current block is reconstructed according to the residuals in the spatial domain.

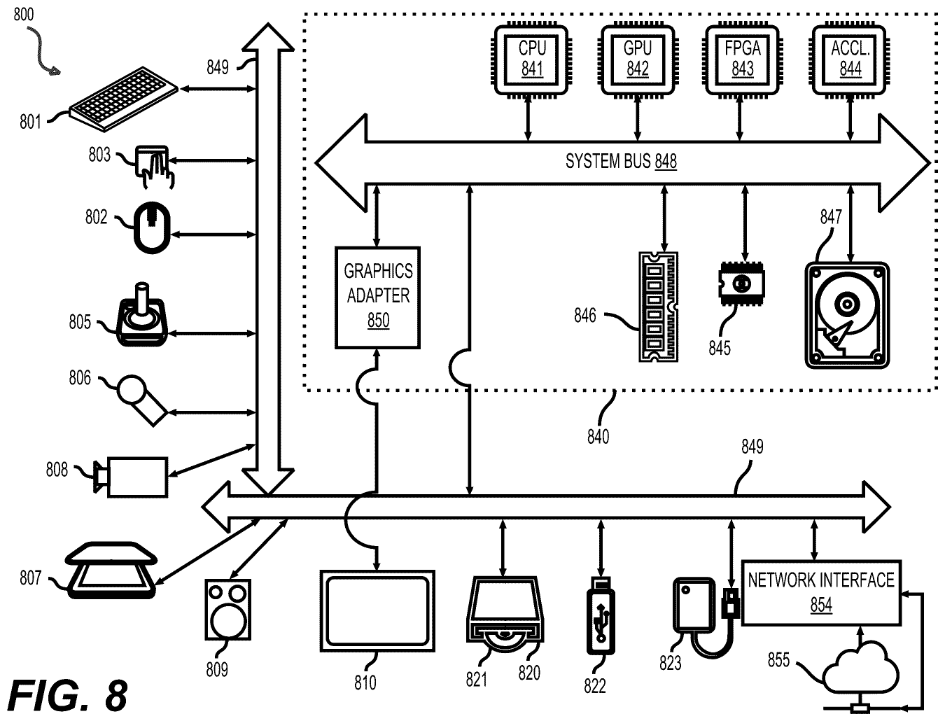

The techniques described above, can be implemented as computer software using computer-readable instructions and physically stored in one or more computer-readable media. For example, FIG. 8 shows a computer system (800) suitable for implementing certain aspects of the disclosed subject matter.

The computer software can be coded using any suitable machine code or computer language, that may be subject to assembly, compilation, linking, or like mechanisms to create code comprising instructions that can be executed directly, or through interpretation, micro-code execution, and the like, by one or more computer central processing units (CPUs), Graphics Processing Units (GPUs), and the like.

The instructions can be executed on various types of computers or components thereof, including, for example, personal computers, tablet computers, servers, smartphones, gaming devices, internet of things devices, and the like.

The components shown in FIG. 8 for computer system (800) are examples and are not intended to suggest any limitation as to the scope of use or functionality of the computer software implementing aspects of the present disclosure. Neither should the configuration of components be interpreted as having any dependency or requirement relating to any one or combination of components illustrated in the example aspect of computer system (800).

Computer system (800) may include certain human interface input devices. Such a human interface input device may be responsive to input by one or more human users through, for example, tactile input (such as: keystrokes, swipes, data glove movements), audio input (such as: voice, clapping), visual input (such as: gestures), olfactory input (not depicted). The human interface devices can also be used to capture certain media not necessarily directly related to conscious input by a human, such as audio (such as: speech, music, ambient sound), images (such as: scanned images, photographic images obtain from a still image camera), video (such as two-dimensional video, three-dimensional video including stereoscopic video).

Input human interface devices may include one or more of (only one of each depicted): keyboard (801), mouse (802), trackpad (803), touch screen (810), data-glove (not shown), joystick (805), microphone (806), scanner (807), camera (808).

Computer system (800) may also include certain human interface output devices. Such human interface output devices may be stimulating the senses of one or more human users through, for example, tactile output, sound, light, and smell/taste. Such human interface output devices may include tactile output devices (for example tactile feedback by the touch-screen (810), data-glove (not shown), or joystick (805), but there can also be tactile feedback devices that do not serve as input devices), audio output devices (such as: speakers (809), headphones (not depicted)), visual output devices (such as screens (810) to include CRT screens, LCD screens, plasma screens, OLED screens, each with or without touch-screen input capability, each with or without tactile feedback capability-some of which may be capable to output two dimensional visual output or more than three dimensional output through means such as stereographic output; virtual-reality glasses (not depicted), holographic displays and smoke tanks (not depicted)), and printers (not depicted).

Computer system (800) can also include human accessible storage devices and their associated media such as optical media including CD/DVD ROM/RW (820) with CD/DVD or the like media (821), thumb-drive (822), removable hard drive or solid state drive (823), legacy magnetic media such as tape and floppy disc (not depicted), specialized ROM/ASIC/PLD based devices such as security dongles (not depicted), and the like.

Those skilled in the art should also understand that term “computer readable media” as used in connection with the presently disclosed subject matter does not encompass transmission media, carrier waves, or other transitory signals.

Computer system (800) can also include an interface (854) to one or more communication networks (855). Networks can for example be wireless, wireline, optical. Networks can further be local, wide-area, metropolitan, vehicular and industrial, real-time, delay-tolerant, and so on. Examples of networks include local area networks such as Ethernet, wireless LANs, cellular networks to include GSM, 3G, 4G, 5G, LTE and the like, TV wireline or wireless wide area digital networks to include cable TV, satellite TV, and terrestrial broadcast TV, vehicular and industrial to include CANBus, and so forth. Certain networks commonly require external network interface adapters that attached to certain general purpose data ports or peripheral buses (849) (such as, for example USB ports of the computer system (800)); others are commonly integrated into the core of the computer system (800) by attachment to a system bus as described below (for example Ethernet interface into a PC computer system or cellular network interface into a smartphone computer system). Using any of these networks, computer system (800) can communicate with other entities. Such communication can be uni-directional, receive only (for example, broadcast TV), uni-directional send-only (for example CANbus to certain CANbus devices), or bi-directional, for example to other computer systems using local or wide area digital networks. Certain protocols and protocol stacks can be used on each of those networks and network interfaces as described above.

Aforementioned human interface devices, human-accessible storage devices, and network interfaces can be attached to a core (840) of the computer system (800).

The core (840) can include one or more Central Processing Units (CPU) (841), Graphics Processing Units (GPU) (842), specialized programmable processing units in the form of Field Programmable Gate Areas (FPGA) (843), hardware accelerators for certain tasks (844), graphics adapters (850), and so forth. These devices, along with Read-only memory (ROM) (845), Random-access memory (846), internal mass storage such as internal non-user accessible hard drives, SSDs, and the like (847), may be connected through a system bus (848). In some computer systems, the system bus (848) can be accessible in the form of one or more physical plugs to enable extensions by additional CPUs, GPU, and the like. The peripheral devices can be attached either directly to the core's system bus (848), or through a peripheral bus (849). In an example, the screen (810) can be connected to the graphics adapter (850). Architectures for a peripheral bus include PCI, USB, and the like.

CPUs (841), GPUs (842), FPGAs (843), and accelerators (844) can execute certain instructions that, in combination, can make up the aforementioned computer code. That computer code can be stored in ROM (845) or RAM (846). Transitional data can also be stored in RAM (846), whereas permanent data can be stored for example, in the internal mass storage (847). Fast storage and retrieve to any of the memory devices can be enabled through the use of cache memory, that can be closely associated with one or more CPU (841), GPU (842), mass storage (847), ROM (845), RAM (846), and the like.

The computer readable media can have computer code thereon for performing various computer-implemented operations. The media and computer code can be those specially designed and constructed for the purposes of the present disclosure, or they can be of the kind well known and available to those having skill in the computer software arts.

As an example and not by way of limitation, the computer system having architecture (800), and specifically the core (840) can provide functionality as a result of processor(s) (including CPUs, GPUs, FPGA, accelerators, and the like) executing software embodied in one or more tangible, computer-readable media. Such computer-readable media can be media associated with user-accessible mass storage as introduced above, as well as certain storage of the core (840) that are of non-transitory nature, such as core-internal mass storage (847) or ROM (845). The software implementing various aspects of the present disclosure can be stored in such devices and executed by core (840). A computer-readable medium can include one or more memory devices or chips, according to particular needs. The software can cause the core (840) and specifically the processors therein (including CPU, GPU, FPGA, and the like) to execute particular processes or particular parts of particular processes described herein, including defining data structures stored in RAM (846) and modifying such data structures according to the processes defined by the software. In addition or as an alternative, the computer system can provide functionality as a result of logic hardwired or otherwise embodied in a circuit (for example: accelerator (844)), which can operate in place of or together with software to execute particular processes or particular parts of particular processes described herein. Reference to software can encompass logic, and vice versa, where appropriate. Reference to a computer-readable media can encompass a circuit (such as an integrated circuit (IC)) storing software for execution, a circuit embodying logic for execution, or both, where appropriate. The present disclosure encompasses any suitable combination of hardware and software.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

While this disclosure has described several examples of aspects, there are alterations, permutations, and various substitute equivalents, which fall within the scope of the disclosure. It will thus be appreciated that those skilled in the art will be able to devise numerous systems and methods which, although not explicitly shown or described herein, embody the principles of the disclosure and are thus within the spirit and scope thereof.

The above disclosure also encompasses the features noted below. The features may be combined in various manners and are not limited to the combinations noted below.
(1) A method of video decoding, the method including: receiving a bitstream that comprises coded information of a current block, the coded information of the current block comprising coded bits of quantized transform coefficients in a transform domain of the current block, the coded information being indicative of at least a scaling factor to be used during a dequantization of the quantized transform coefficients; determining one or more quantization shifting offsets for a reconstruction of transform coefficients in the transform domain based on at least the scaling factor; reconstructing the transform coefficients from the quantized transform coefficients based on the one or more quantization shifting offsets; calculating residuals in a spatial domain of the current block based on the transform coefficients in the transform domain; and reconstructing the current block according to the residuals in the spatial domain.
(2) The method of feature (1), the method including: determining a single quantization shifting offset value for the transform coefficients.
(3) The method of any of features (1) to (2), in which at least the scaling factor include a single scaling factor value for the transform coefficients associated with positions in the transform domain of the current block, the method including at least one of determining the single quantization shifting offset value according to a linear function of the single scaling factor value, parameters of the linear function being predefined constants; and/or determining the single quantization shifting offset value according to a predefined function of the single scaling factor value.
(4) The method of any of features (1) to (3), in which at least the scaling factor include scaling factor values respectively for the transform coefficients at respective positions in the transform domain of the current block, the determining the single quantization shifting offset value further includes at least one of determining the single quantization shifting offset value according to a linear function of a combination of the scaling factor values, parameters of the linear function being predefined constants; and/or determining the single quantization shifting offset value according to a predefined function of a combination of the scaling factor values.
(5) The method of any of features (1) to (4), in which the determining the one or more quantization shifting offsets includes determining respective quantization shifting offset values for the transform coefficients at respective positions in the transform domain of the current block.
(6) The method of any of features (1) to (5), in which at least the scaling factor include a single scaling factor value for the transform coefficients associated with positions in the transform domain of the current block, and the determining the respective quantization shifting offset values further includes determining a first quantization shifting offset value for a first transform coefficient at a first position in the transform domain of the current block according to a linear function of a combination of the single scaling factor value and the first position, parameters of the linear function being predefined constants; and/or determining the first quantization shifting offset value according to a first predefined function of the single scaling factor value, the first predefined function being associated with the first position.
(7) The method of any of features (1) to (6), in which at least the scaling factor include respective scaling factor values for the transform coefficients at respective positions in the transform domain of the current block, the determining the quantization shifting offset values further includes at least one of: determining a first quantization shifting offset value for a first transform coefficient at a first position in the transform domain of the current block according to a linear function of a first scaling factor at the first position, parameters of the linear function being predefined constants; and/or determining the first quantization shifting offset value for the first transform coefficient at the first position in the transform domain of the current block according to a predefined function of the first scaling factor at the first position.
(8) A method of video decoding, the method including: receiving a bitstream that comprises coded information of a current block, the coded information of the current block comprising coded bits of quantized transform coefficients in a transform domain of the current block, the coded information being indicative of a quantization shifting offset to be used for a reconstruction of at least a first transform coefficient in the transform domain; reconstructing at least the first transform coefficient in the transform domain based on the quantization shifting offset; calculating residuals in a spatial domain of the current block based on at least the first transform coefficient in the transform domain; and reconstructing the current block according to the residuals in the spatial domain.
(9) The method of feature (8), the method including: decoding one or more syntax elements from a high level syntax, the one or more syntax elements indicating a value of the quantization shifting offset for a video portion associated with the high level syntax or a sign of the quantization shifting offset for the video portion associated with the high level syntax, the high level syntax comprising at least one of a sequence level syntax, a picture level syntax, a slice level syntax and a tile level syntax.
(10) The method of any of features (8) to (9), the method including: decoding one or more syntax elements of the current block, the one or more syntax elements indicating a value of the quantization shifting offset of the current block or a sign of the quantization shifting offset of the current block.
(11) The method of any of features (8) to (10), the method including: decoding one or more syntax elements of the current block, the one or more syntax elements indicating a value of the quantization shifting offset for a subset of transform coefficients in the transform domain of the current block or a sign of the quantization shifting offset for the subset of transform coefficients, the subset of transform coefficients including the first transform coefficient.
(12) The method of any of features (8) to (11), in which the coded information includes one or more syntax elements that indicates a combination of the quantization shifting offset and a scaling factor to be used during a dequantization of the quantized transform coefficients.
(13) The method of any of features (8) to (12), in which the one or more syntax elements include an index indicating the combination of the quantization shifting offset and the scaling factor.
(14) The method of any of features (8) to (13), in which the one or more syntax elements include an index indicating a combination of the quantization shifting offset and a lookup table for the scaling factor.
(15) The method of any of features (8) to (14), in which the one or more syntax elements include an index indicating a combination of a first lookup table for the quantization shifting offset and a second lookup table for the scaling factor.
(16) The method of any of features (8) to (15), in which the coded information is indicative of a first quantization shifting offset to be used for a first color component and a second quantization shifting offset to be used for a second color component.
(17) A method of video encoding, the method including: determining one or more quantization shifting offsets for a reconstruction of transform coefficients in a transform domain of a current block based on at least a scaling factor that is used during a dequantization of quantized transform coefficients; reconstructing the transform coefficients from the quantized transform coefficients based on the one or more quantization shifting offsets; calculating residuals in a spatial domain of the current block based on the transform coefficients in the transform domain; reconstructing the current block according to the residuals in the spatial domain; and encoding the current block as coded information in a bitstream, the coded information being indicative of at least the scaling factor.
(18) The method of feature (17), in which at least the scaling factor include a single scaling factor value for the transform coefficients associated with positions in the transform domain of the current block, the method comprises at least one of: determining a single quantization shifting offset value according to a linear function of the single scaling factor value, parameters of the linear function being predefined constants; and determining the single quantization shifting offset value according to a predefined function of the single scaling factor value.
(19) The method of any of features (17) to (18), in which at least the scaling factor include scaling factor values respectively for the transform coefficients at respective positions in the transform domain of the current block, the method comprises at least one of: determining a single quantization shifting offset value according to a linear function of a combination of the scaling factor values, parameters of the linear function being predefined constants; and determining the single quantization shifting offset value according to a predefined function of a combination of the scaling factor values.
(20) The method of any of features (17) to (19), in which the determining the one or more quantization shifting offsets comprises: determining respective quantization shifting offset values for the transform coefficients at respective positions in the transform domain of the current block.
(21) The method of any of features (17) to (20), in which at least the scaling factor include a single scaling factor value for the transform coefficients associated with positions in the transform domain of the current block, and the determining the respective quantization shifting offset values further comprises: determining a first quantization shifting offset value for a first transform coefficient at a first position in the transform domain of the current block according to a linear function of a combination of the single scaling factor value and the first position, parameters of the linear function being predefined constants; and/or determining the first quantization shifting offset value according to a first predefined function of the single scaling factor value, the first predefined function being associated with the first position.
(22) The method of any of features (17) to (21), in which at least the scaling factor include respective scaling factor values for the transform coefficients at respective positions in the transform domain of the current block, the determining the quantization shifting offset values further comprises at least one of: determining a first quantization shifting offset value for a first transform coefficient at a first position in the transform domain of the current block according to a linear function of a first scaling factor at the first position, parameters of the linear function being predefined constants; and/or determining the first quantization shifting offset value for the first transform coefficient at the first position in the transform domain of the current block according to a predefined function of the first scaling factor at the first position.
(23) A method of video encoding, the method including: deriving a quantization shifting offset for a reconstruction of at least a first transform coefficient in a transform domain of a current block from quantized transform coefficients; and encoding the current block into coded information in a bitstream, the coded information being indicative of the quantization shifting offset.
(24) The method of feature (23), in which wherein the coded information includes one or more syntax elements from a high level syntax, the one or more syntax elements indicating a value of the quantization shifting offset for a video portion associated with the high level syntax or a sign of the quantization shifting offset for the video portion associated with the high level syntax, the high level syntax comprising at least one of a sequence level syntax, a picture level syntax, a slice level syntax and a tile level syntax.
(25) The method of any of features (23) to (24), in which the coded information includes one or more syntax elements of the current block, the one or more syntax elements indicates a value of the quantization shifting offset of the current block or a sign of the quantization shifting offset of the current block.
(26) The method of any of features (23) to (25), in which the coded information includes one or more syntax elements of the current block, the one or more syntax elements indicates a value of the quantization shifting offset for a subset of transform coefficients in the transform domain of the current block or a sign of the quantization shifting offset for the subset of transform coefficients, the subset of transform coefficients including the first transform coefficient.
(27) The method of any of features (23) to (26), in which the coded information includes one or more syntax elements that indicates a combination of the quantization shifting offset and a scaling factor to be used during a dequantization of the quantized transform coefficients.
(28) The method of any of features (23) to (27), in which the one or more syntax elements include an index indicating the combination of the quantization shifting offset and the scaling factor.
(29) The method of any of features (23) to (28), in which the one or more syntax elements include an index indicating a combination of the quantization shifting offset and a lookup table for the scaling factor.
(30) The method of any of features (23) to (29), in which the one or more syntax elements include an index indicating a combination of a first lookup table for the quantization shifting offset and a second lookup table for the scaling factor.
(31) The method of any of features (23) to (30), in which the coded information is indicative of a first quantization shifting offset to be used for a first color component and a second quantization shifting offset to be used for a second color component.
(32) A method of processing visual media data, the method including processing a bitstream of visual media data according to a format rule. The bitstream includes coded information of a current block, the coded information of the current block includes coded bits of quantized transform coefficients in a transform domain of the current block, the coded information is indicative of at least a scaling factor to be used during a dequantization of the quantized transform coefficients. The format rule specifies that: one or more quantization shifting offsets for a reconstruction of transform coefficients in the transform domain are determined based on at least the scaling factor; the transform coefficients are reconstructed from the quantized transform coefficients based on the one or more quantization shifting offsets; residuals in a spatial domain of the current block are calculated based on the transform coefficients in the transform domain; and the current block is reconstructed according to the residuals in the spatial domain.
(33) An apparatus for video decoding, including processing circuitry that is configured to perform the method of any of features (1) to (16).
(37) An apparatus for video encoding, including processing circuitry that is configured to perform the method of any of features (17) to (31).
(38) A non-transitory computer-readable storage medium storing instructions which when executed by at least one processor cause the at least one processor to perform the method of any of features (1) to (32).

What is claimed is:

1. A method of video decoding, comprising:
receiving a bitstream that comprises coded information of a current block, the coded information of the current block comprising coded bits of quantized transform coefficients in a transform domain of the current block, the coded information being indicative of at least a scaling factor to be used during a dequantization of the quantized transform coefficients;
determining one or more quantization shifting offsets for a reconstruction of transform coefficients in the transform domain based on at least the scaling factor;
reconstructing the transform coefficients from the quantized transform coefficients based on the one or more quantization shifting offsets;
calculating residuals in a spatial domain of the current block based on the transform coefficients in the transform domain; and
reconstructing the current block according to the residuals in the spatial domain.

2. The method of claim 1, wherein the determining the one or more quantization shifting offsets comprises:
determining a single quantization shifting offset value for the transform coefficients.

3. The method of claim 2, wherein at least the scaling factor include a single scaling factor value for the transform coefficients associated with positions in the transform domain of the current block, the determining the single quantization shifting offset value further comprises at least one of:
determining the single quantization shifting offset value according to a linear function of the single scaling factor value, parameters of the linear function being predefined constants;
and/or determining the single quantization shifting offset value according to a predefined function of the single scaling factor value.

4. The method of claim 2, wherein at least the scaling factor include scaling factor values respectively for the transform coefficients at respective positions in the transform domain of the current block, the determining the single quantization shifting offset value further comprises at least one of:
determining the single quantization shifting offset value according to a linear function of a combination of the scaling factor values, parameters of the linear function being predefined constants; and/or
determining the single quantization shifting offset value according to a predefined function of a combination of the scaling factor values.

5. The method of claim 1, wherein the determining the one or more quantization shifting offsets comprises:
determining respective quantization shifting offset values for the transform coefficients at respective positions in the transform domain of the current block.

6. The method of claim 5, wherein at least the scaling factor include a single scaling factor value for the transform coefficients associated with positions in the transform domain of the current block, and the determining the respective quantization shifting offset values further comprises:
determining a first quantization shifting offset value for a first transform coefficient at a first position in the transform domain of the current block according to a linear function of a combination of the single scaling factor value and the first position, parameters of the linear function being predefined constants; and/or
determining the first quantization shifting offset value according to a first predefined function of the single scaling factor value, the first predefined function being associated with the first position.

7. The method of claim 5, wherein at least the scaling factor include respective scaling factor values for the transform coefficients at respective positions in the transform domain of the current block, the determining the quantization shifting offset values further comprises at least one of:
determining a first quantization shifting offset value for a first transform coefficient at a first position in the transform domain of the current block according to a linear function of a first scaling factor at the first position, parameters of the linear function being predefined constants;
and/or determining the first quantization shifting offset value for the first transform coefficient at the first position in the transform domain of the current block according to a predefined function of the first scaling factor at the first position.

8. A method of video decoding, comprising:
receiving a bitstream that comprises coded information of a current block, the coded information of the current block comprising coded bits of quantized transform coefficients in a transform domain of the current block, the coded information being indicative of a quantization shifting offset to be used for a reconstruction of at least a first transform coefficient in the transform domain;
reconstructing at least the first transform coefficient in the transform domain based on the quantization shifting offset;
calculating residuals in a spatial domain of the current block based on at least the first transform coefficient in the transform domain; and
reconstructing the current block according to the residuals in the spatial domain.

9. The method of claim 8, further comprising:
decoding one or more syntax elements from a high level syntax, the one or more syntax elements indicating a value of the quantization shifting offset for a video portion associated with the high level syntax or a sign of the quantization shifting offset for the video portion associated with the high level syntax, the high level syntax comprising at least one of a sequence level syntax, a picture level syntax, a slice level syntax and a tile level syntax.

10. The method of claim 8, further comprising:
decoding one or more syntax elements of the current block, the one or more syntax elements indicating a value of the quantization shifting offset of the current block or a sign of the quantization shifting offset of the current block.

11. The method of claim 8, further comprising:
decoding one or more syntax elements of the current block, the one or more syntax elements indicating a value of the quantization shifting offset for a subset of transform coefficients in the transform domain of the current block or a sign of the quantization shifting offset for the subset of transform coefficients, the subset of transform coefficients including the first transform coefficient.

12. The method of claim 8, wherein the coded information includes one or more syntax elements that indicates a combination of the quantization shifting offset and a scaling factor to be used during a dequantization of the quantized transform coefficients.

13. The method of claim 12, wherein the one or more syntax elements include an index indicating the combination of the quantization shifting offset and the scaling factor.

14. The method of claim 12, wherein the one or more syntax elements include an index indicating a combination of the quantization shifting offset and a lookup table for the scaling factor.

15. The method of claim 12, wherein the one or more syntax elements include an index indicating a combination of a first lookup table for the quantization shifting offset and a second lookup table for the scaling factor.

16. The method of claim 8, wherein the coded information is indicative of a first quantization shifting offset to be used for a first color component and a second quantization shifting offset to be used for a second color component.

17. A method of video encoding, comprising:
determining one or more quantization shifting offsets for a reconstruction of transform coefficients in a transform domain of a current block based on at least a scaling factor that is used during a dequantization of quantized transform coefficients;
reconstructing the transform coefficients from the quantized transform coefficients based on the one or more quantization shifting offsets;
calculating residuals in a spatial domain of the current block based on the transform coefficients in the transform domain;
reconstructing the current block according to the residuals in the spatial domain; and
encoding the current block as coded information in a bitstream, the coded information being indicative of at least the scaling factor.

18. The method of claim 17, wherein at least the scaling factor include a single scaling factor value for the transform coefficients associated with positions in the transform domain of the current block, the method comprises at least one of:
determining a single quantization shifting offset value according to a linear function of the single scaling factor value, parameters of the linear function being predefined constants; and
determining the single quantization shifting offset value according to a predefined function of the single scaling factor value.

19. The method of claim 17, wherein at least the scaling factor include scaling factor values respectively for the transform coefficients at respective positions in the transform domain of the current block, the method comprises at least one of:
determining a single quantization shifting offset value according to a linear function of a combination of the scaling factor values, parameters of the linear function being predefined constants; and
determining the single quantization shifting offset value according to a predefined function of a combination of the scaling factor values.

20. The method of claim 17, wherein the determining the one or more quantization shifting offsets comprises:
determining respective quantization shifting offset values for the transform coefficients at respective positions in the transform domain of the current block.
